(19) United States
(12) Patent Application Publication
(10) Pub. No.: US 2007/0222995 A1
(43) Pub. Date: Sep. 27, 2007

(54) Artifact having a textured metal surface with nanometer-scale features and method for fabricating same

(76) Inventor: Jennifer Lu, Milpitas, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/389,972

(22) Filed: Mar. 27, 2006

(51) Int. Cl. G01N 21/55

(52) U.S. Cl. 356/445

(57) ABSTRACT

An artifact having a textured metal surface with nanometer-scale features includes a substrate, a substructure over the substrate, the substructure comprising a periodic array of nanometer-scale structural elements comprising an inorganic oxide, and a metal film over the substructure.

### BACKGROUND OF THE INVENTION

Surface plasmon resonance (SPR) is an optical method for measuring the refractive index of very thin layers of material adsorbed on a metal film. SPR is used to measure biomolecular interactions in real-time in a label-free environment. Label-free detection refers to a method for determining the identity of a biomolecule without fluorescence tagging. For example, in the case of protein adsorption, the refractive index of a thin metal film in a buffer solution (e.g., an aqueous solution) differs depending on whether an adsorbate is bound on its surface and can be easily quantitatively measured using SPR.

The specific binding of biomolecules changes the refractive index of the metal film. The change in refractive index is measured as a change in resonance angle or resonance wavelength. The change in refractive index on the surface is linear with respect to the quantity of molecules specifically bound.

The SPR technique exploits the fact that, under certain conditions, surface plasmons on metallic surfaces can be excited by photons, thereby transforming a photon into a surface plasmon. The conditions depend on the properties of the metal film, the wavelength of the incident light, temperature, and the refractive index of the media on both sides of the metal film. Since the metal film, the wavelength of the incident light and temperature are kept constant, the SPR signal is directly dependent on the change of the refractive index of the medium on the side of the SPR surface having the metal film due to the adsorption.

At an interface between two transparent media of different refractive indices (e.g., glass and water), light coming from the side of higher refractive index is partly reflected and partly refracted. Above a certain critical angle of incidence, no light is refracted across the interface, and total internal reflection is observed. While incident light is totally reflected, the electromagnetic field component penetrates a short distance (tens of nanometers) into the medium of the lower refractive index creating an exponentially-decaying evanescent wave. If the interface between the media is coated with a thin film of metal (such as gold, silver, platinum, or another chemically-stable metal), and the light is monochromatic and polarized, the intensity of the reflected light is reduced at a specific angle of incidence, producing a sharp shadow. The sharp shadow is due to surface plasmon resonance and appears as a narrow line due to the resonant energy transfer between the photons of the evanescent wave and surface plasmons.

The resonance conditions are influenced by material adsorbed onto the thin metal film. For example, the velocity of the plasmons changes when the composition of the medium changes. Because of the change in velocity, in other words, the change in momentum, the angle of incidence at which the resonance occurs changes accordingly. Therefore, a monolayer of antigen molecules on the surface of the metal film has a characteristic surface plasmon resonance angle. The angle shifts when the corresponding antibody binds to the antigen molecules on the surface. Therefore, measuring surface plasmon resonance via the resonance angle can be used to determine whether a binding event takes place. Moreover, reaction rate constants as well as equilibrium constants can be determined. This type of SPR-based biosensing is referred to as angular SPR. Alternatively, the angle of incidence can remain fixed and the wavelength of the incident light can be varied until resonance occurs. This means that the analyte and ligand association and dissociation can be observed and rate constants and equilibrium constants can be calculated.

SPR is useful for probing the interactions of various biomolecules with various ligands, biomolecules, and membranes, including, for example, protein:ligand; protein:protein; protein:DNA; and protein:membrane binding. It provides not only a method for identifying these interactions and quantifying their equilibrium constants, kinetic constants and underlying energenitics, but also for performing label-free biomolecule detection.

In a typical SPR biosensing application, one interactant in the interactant pair (i.e., a ligand or biomolecule) is immobilized on a glass slide coated with a thin film of metal, such as gold. The immobilized interactant forms a thin layer. The other interactant is located in an aqueous buffer solution and is induced to flow across the surface of the glass slide. When light of a given wavelength is directed through the glass slide and onto the surface of the metal film at an angle near the so-called “surface plasmon resonance” condition for the wavelength, the optical reflectivity of the metal film changes very sensitively with the concentration of biomolecules on the surface of the metal film or in a thin coating on the metal film. The extent of binding between the solution-phase interactant and the immobilized interactant is easily observed and quantified by measuring the resonance angle or the resonance frequency of the reflected light. The SPR-detected concentration measurement is highly sensitive without the need for any fluorescent or other labeling of the interactants.

The use of a textured surface having nanometer-scale metallic features instead of a smooth metal surface enhances the ability to detect biomolecules using SPR. Measurement of SPR at a flat metal surface is difficult due to angular dependence and temperature sensitivity. A metal surface (e.g., gold, silver, platinum) with nanometer-scale features relaxes the stringent angular and temperature requirements and exhibits strong absorption in the ultraviolet (UV)-visible frequency range. This absorption is referred to as localized surface plasmon resonance (LSPR). LSPR can be thought of as an optical enhancement of the electromagnetic field facilitated by the presence of the nanometer scale features. Moreover, a nanotextured surface provides larger surface area than a smooth surface. Therefore, a nanotextured surface can have a higher population of the immobilized interactant and has a better chance to capture interactants of interest.

Similarly, the sensitivity of electrochemical impedance spectroscopy (EIS) can be enhanced by the use of a metal substrate having a nanometer-scale textured surface. EIS is an effective tool for screening anti-cancer drugs by determining the interaction between immobilized DNA and potential drugs. In one example, the sensitivity of SPR detection of nogalamycin, an anti-tumor drug, was 40 times greater using SPR on a textured metal surface than on a smooth metal surface. The increased sensitivity results from the greater ability of biomolecules to attach to targets arranged in a concentric fashion on a surface textured with nanometer-scale particles.

Unfortunately, current methods for preparing nanometer-scale textured surfaces suffer from surface defects and from inferior process robustness. For example, electrochemical deposition has been used to deposit nanometer-scale gold particles on a surface, but accurate control of the particle size and density is difficult. In another process, textured nanometer-scale gold surfaces have been prepared by depositing a thin layer of gold onto a surface coated with a monolayer of polystyrene spheres. Unfortunately, it is difficult to obtain a consistent monolayer of the spheres. This causes irregularities in the layer of gold. Further, the chemical suspensions that are used to deposit the polystyrene spheres have a limited shelf life.

### SUMMARY

In an embodiment, an artifact having a textured metal surface with nanometer-scale features comprises a substrate, a substructure over the substrate, the substructure comprising a periodic array of nanometer-scale structural elements comprising an inorganic oxide, and a metal film over the substructure. In an example application, the artifact can be used to enhance the sensitivity of an apparatus used to perform surface plasmon resonance analysis.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIGS. 1A through 1D are schematic diagrams collectively illustrating an embodiment of a process for creating an artifact having a textured metal surface with nanometer-scale features.

FIG. 2 is a schematic plan view of the substructure with nanometer-scale features shown in FIG. 1C.

FIGS. 3A through 3D are schematic diagrams collectively illustrating an alternative embodiment of a process for creating an artifact having a textured metal surface with nanometer-scale features.

FIG. 4 is a flowchart showing a method of forming an artifact having textured metal surface with nanometer-scale features.

FIG. 5 is a schematic diagram showing an atomic force microscopy (AFM) image of an artifact having a textured metal surface with nanometer-scale features in accordance with an embodiment of the invention.

FIG. 6A is a block diagram showing the basic components of an instrument for performing surface plasmon resonance analysis.

FIG. 6B is an enlarged view of the metal film of the instrument shown in FIG. 6A.

### DETAILED DESCRIPTION

An artifact having a textured metal surface with nanometer-scale features will be described below in the context of an artifact whose textured metal surface is used in a surface plasmon resonance (SPR) biosensing application. However, the artifact having a textured metal surface with nanometer-scale features can be used in other applications in which a nanometer-scale textured metal surface is needed.

Prior to describing embodiments of the invention, a description of a block copolymer is provided to aid in the understanding of the embodiments to be described below. The term “polymer” refers to a chemical compound formed by polymerization and consisting essentially of repeating structural units. The basic chemical “units” that are used in building a polymer are referred to as “repeat units.” A polymer may have a large number of repeat units or a polymer may have relatively few repeat units, in which case the polymer is often referred to as an “oligomer.”

When a polymer is made by linking only one type of repeat unit together, it is referred to as a “homopolymer.” When two (or more) different types of repeat units are joined in the same polymer chain, the polymer is called a “copolymer.” In copolymers, the different types of repeat units can be joined together in different arrangements. For instance, two repeat units may be arranged in an alternating fashion, in which case the polymer is referred to as an “alternating copolymer.” As another example, in a “random copolymer,” the two repeat units may follow in any order. Further, in a “block copolymer,” all of one type of repeat unit are grouped together, and all of the other type of repeat unit are grouped together. Thus, a block copolymer can generally be thought of as two homopolymers joined in tandem. A block copolymer can include two or more units of a polymer chain joined together by covalent bonds. A “diblock copolymer” is a block copolymer that contains only two units joined together by a covalent bond. A “triblock copolymer” is a block copolymer that contains only three units joined together by covalent bonds.

A polymer that may be processed to deliver an inorganic payload on the surface of a substrate is referred to herein as a “vector polymer.” As described further below, such a vector polymer self-assembles into a desired structure for controlling the size and/or distribution of nanoparticles produced by the inorganic payload carried by such vector polymer. Thus, the vector polymer self-assembles into a desired structure of inorganic material-containing domains. The non-payload (e.g., organic) components of the vector polymer can then be removed, resulting in the inorganic nanoparticles remaining on the substrate with their size and/or distribution controlled by the vector polymer's self-assembly. While in certain exemplary embodiments described herein a diblock copolymer (A-B) is used as a vector polymer for carrying an inorganic payload, the scope of the present invention is not so limited. Rather, any polymer (e.g., triblock polymer, etc.) that is capable of self-assembly and in which at least one repeat unit thereof includes an inorganic payload may be utilized in accordance with the concepts presented herein. For instance, in certain embodiments a block copolymer A-B-A may be used. Further, in certain embodiments, a mixture of block copolymers (e.g., diblock copolymers) and homopolymers or a miscible blend of two homopolymers (A) and (B) is used to form a film containing self-assembling polymers. As an example, a diblock polymer and two homopolymers are used for forming the film containing self-assembling polymers.

Amphiphilic block copolymers are known self-assembly systems in which chemically distinct blocks microphase-separate into the periodic domains. The domains adopt a variety of nanoscale morphologies, such as lamellar, double gyroid, cylindrical, or spherical, depending on the polymer chemistry and molecular weight. Embodiments are described herein in which such amphiphilic block copolymers are used as carriers of inorganic payloads, wherein the self-assembly of the block copolymers into a desired nanoscale morphology results in a controlled arrangement of the inorganic nanoparticles formed from the carried inorganic payloads.

The block that contains the inorganic payload is referred to as a payload-containing block. One or more instances of such a payload-containing block is present in each block polymer. For instance, in certain embodiments, a diblock copolymer has one block that is a payload-containing block and another block that contains no inorganic payload. The block that contains no inorganic payload is referred to as the matrix. As described further below, a block copolymer deposited on the surface of a substrate and subject to annealing will self-assemble into a predetermined structure (i.e., a desired nanoscale morphology). The structure into which the block copolymer self-assembles controls the size and relative spacing of the inorganic nanoparticles formed from the inorganic payload carried by the block copolymer.

Various techniques can be used for forming block copolymers containing an inorganic payload. One exemplary technique involves complexation of an inorganic payload (e.g., atoms of an inorganic species) with a block of a diblock copolymer. For instance, incorporation of an inorganic species, which may be a metal, such as iron, cobalt, and molybdenum, into one block of a diblock copolymer is accomplished by complexation of the atoms of the inorganic species with the pyridine units of polystyrene-b-poly(vinyl pyridine) (PS-b-PVP). Another exemplary technique involves direct synthesis of a payload-containing diblock copolymer. For instance, sequential living polymerization of the nonmetal-containing styrene monomer followed by the inorganic species-containing monomer of ferrocenylethylmethylsilane to form polystyrene-b-poly(ferrocenylethylmethylsilane) (PS-b-PFEMS) is an exemplary technique for direct synthesis of an inorganic species-containing diblock copolymer.

By controlling the volume of each of the blocks (A and B) of the diblock copolymer, the structures into which the diblock copolymer self-assembles during annealing can be controlled. The volume ratio between the blocks of the diblock copolymer determines the morphology, such as lamellar, double gyroid, cylindrical, or spherical, of the microdomains into which the diblock copolymer self-assembles. Additionally, the volumes of the blocks determine the size of the microdomains and the spacing between the microdomains in the matrix after the self-assembly process. Accordingly, a volume ratio between the blocks of a diblock copolymer is first determined based on the desired morphology of the microdomains that are to be formed by the self-assembly process, and the volumes of the blocks are next determined based on the desired size and spacing of the microdomains. The blocks are then deposited onto the surface of a substrate as a thin film. The blocks have the volume and volume ratio that provide the desired morphology, size and spacing.

An annealing process is then performed to cause the diblock copolymers to self-assemble. The microdomains and matrix into which the diblock copolymers self-assemble dictate the size and distribution (e.g., relative spacing) of the inorganic structural elements that will later be formed from the carried inorganic payloads. Further, this self-assembly technique provides a high yield as substantially all of the inorganic structural elements formed by the self-assembled diblock copolymers remain on the substrate after an oxidation process (e.g., UV-ozone or oxygen plasma) treatment is performed to remove the organic component of the diblock copolymer, as will be described further below. The oxidation process additionally oxidizes the inorganic species to form a non-volatile inorganic oxide. The inorganic oxide forms structural elements that collectively constitute a substructure having nanometer-scale features.

In accordance with an embodiment of the invention, a layer of metal is deposited over the substructure. The surface of the metal layer is a textured metal surface having nanometer-scale features. The substructure underlying the metal layer defines the topology of the textured metal surface.

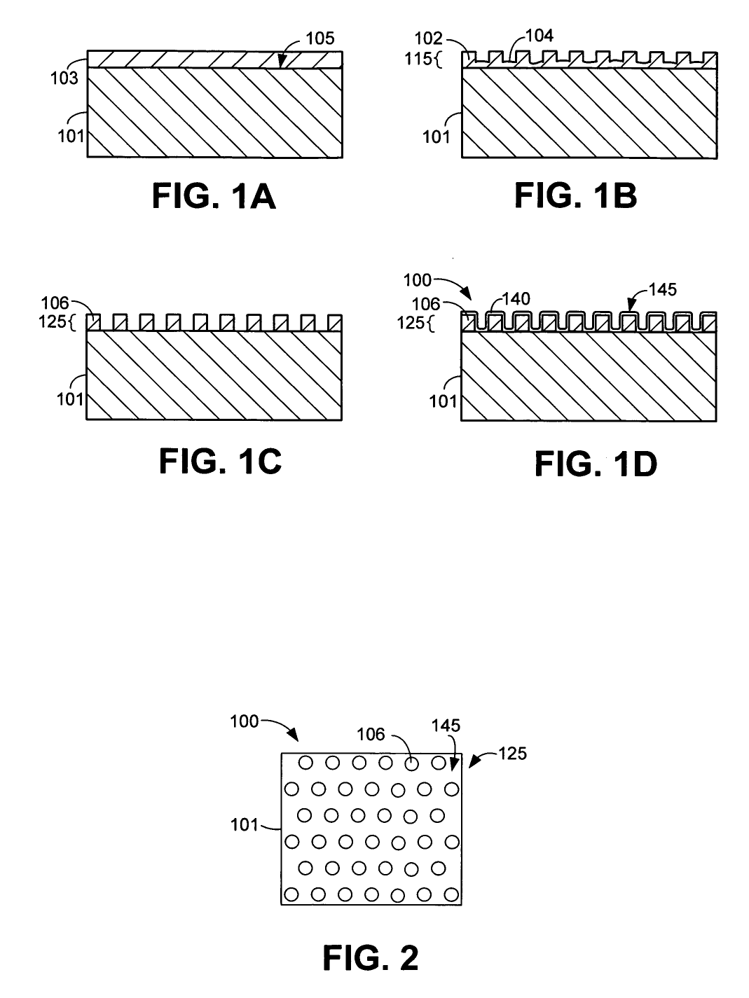

FIGS. 1A through 1D are schematic cross-sectional views showing an artifact having a textured metal surface with nanometer-scale features in accordance with an embodiment of the invention at various stages in its fabrication. FIG. 1A shows a vector polymer film 103 deposited on the surface 105 of a substrate 101. The substrate 101 comprises silicon, quartz, or another suitable substrate material. For an SPR application, the substrate 101 is typically transparent and comprises silicon, quartz, glass or another suitable substrate transparent material. The vector polymer film 103 is deposited on the surface 105 of the substrate 101 by, for example, spin coating, dip coating, or another application process known in the art. The vector polymer film 103 is approximately 50-100 nanometers (nm) thick. Examples of materials that can be used to form the vector polymer film 103 include polystyrene-b-polydimethylsiloxane (PS-PDMS), polyisoprene-b-polydimethylsiloxane (PI-PDMS), polyisoprene-b-polyferrocenylmethylethylsilane (PI-PFEMS), polystyrene-b-polyferrocenylmethylethylsilane (PS-PFEMS), polystyrene-b-polyvinylmethylsiloxane (PS-PVMS), polystyrene-b-polybutadiene (PS-PB), where the polybutadiene (PB) is stained by osmium tetroxide (OSO₄), and polystyrene-b-polyvinylpridine (PS-PVP), where the pyridine group forms a coordination bond with an inorganic species. Other materials that can form a block copolymer can additionally or alternatively be used.

FIG. 1B shows the substrate 101 and the vector polymer film 103 shown in FIG. 1A after the vector polymer film 103 has been annealed. Annealing the vector polymer film 103 causes the vector polymer film 103 to self-assemble into a block copolymer 115 having a nanometer-scale morphology defined by the volume ratio of the two blocks constituting the block copolymer 115. In the example shown, the volume ratio of the blocks that form the block copolymer 115 is such that the block copolymer 115 self-assembles with a cylindrical morphology.

In the example shown in FIG. 1B, self-assembly of the block copolymer 115 results in a periodic array of microdomains embedded in a matrix. An exemplary one of the microdomains is illustrated at 102 and an exemplary part of the matrix is illustrated at 104. In an embodiment, the block copolymer 115 is formed using polystyrene-b-polyferrocenylmethylethylsilane (PS-PFEMS), where the material of the matrix 104 is polystyrene (PS) and the material of the microdomain 102 is polyferrocenylmethylethylsilane (PFEMS). In this example, the microdomain 102 comprises organic material and inorganic species. The inorganic species are silicon and iron that form respective non-volatile oxides. The matrix 104 consists only of organic material. In other examples, the material of the microdomain 102 consists of only one organic species.

FIG. 1C shows the substrate 101 and the block copolymer 115 shown in FIG. 1B after the block copolymer 115 has been subject to oxidation. The block copolymer 115 is oxidized using, for example, oxygen (O₂) plasma etching or ultraviolet (UV)-ozonation, as known in the art. The oxidation process removes the organic components of the block copolymer 115 and converts each inorganic species of the block copolymer 115 into a respective inorganic oxide. Specifically, the oxidation process removes the organic matrix 104 shown in FIG. 1B and the organic component of the microdomains 102. The oxidation process additionally converts the inorganic species in the microdomains 102 to respective inorganic oxides that form posts 106. The posts 106 are periodically arrayed on the surface 105 (FIG. 1A) of the substrate 101 in the same arrangement as the microdomains 102 described above with reference to FIG. 1B. The posts 106 are structural elements that collectively constitute a substructure 125. Using current processing technology, the array of posts 106 has a pitch of approximately 20 nanometers to approximately 100 nanometers and the posts 106 are approximately 5 nanometers to approximately 50 nanometers in diameter.

FIG. 1D shows a thin layer 140 of a metal such as gold, silver, platinum, etc., deposited over the substructure 125 to complete the fabrication of an artifact 100 having a textured metal surface with nanometer-scale features. The metal layer 140 is applied over the nanometer-scale substructure 125 by, for example, sputtering, metal evaporation, or another technique. The surface of the metal layer 140 provides the textured metal surface 145 having nanometer-scale features of the artifact 100. The substructure 125 underlying the metal layer 140 defines the topology of the textured metal surface 145. The substructure 125 comprising a periodic array of the posts 106 as nanometer-scale structural elements provides a high degree of control of both the size and the spacing of the nanometer-scale features of the textured metal surface 145.

When the artifact 100 is used as part of a surface plasmon resonance analysis device, functionalizing biomolecules can easily be attached to the textured metal surface 145 by, for example, a thiol linkage. The functionalizing biomolecules are biomolecules that bind to a specific analyte of interest. In an example, the functionalizing biomolecules are antigens that bind to a specific antibody of interest. The surface area of the textured metal surface 145 is much larger than the area of the surface 105 of the substrate 101 covered by the metal layer 140. Accordingly, for a given area of the surface 105, textured metal surface 145 allows many more functionalizing biomolecules to be available to bind with the analyte of interest than would be available if the functionalizing biomolecules were directly attached to surface 105. The larger surface area of the nanometer-scale textured metal surface 145 increases the probability of the analyte of interest binding to one of the functionalizing biomolecules. This increases the sensitivity of the SPR analysis device. Further, localized surface plasmon resonance occurs when plasmons produced at textured metal surface with nanometer-scale features match the energy and momentum of the incident photons. As a result, the detection sensitivity is increased.

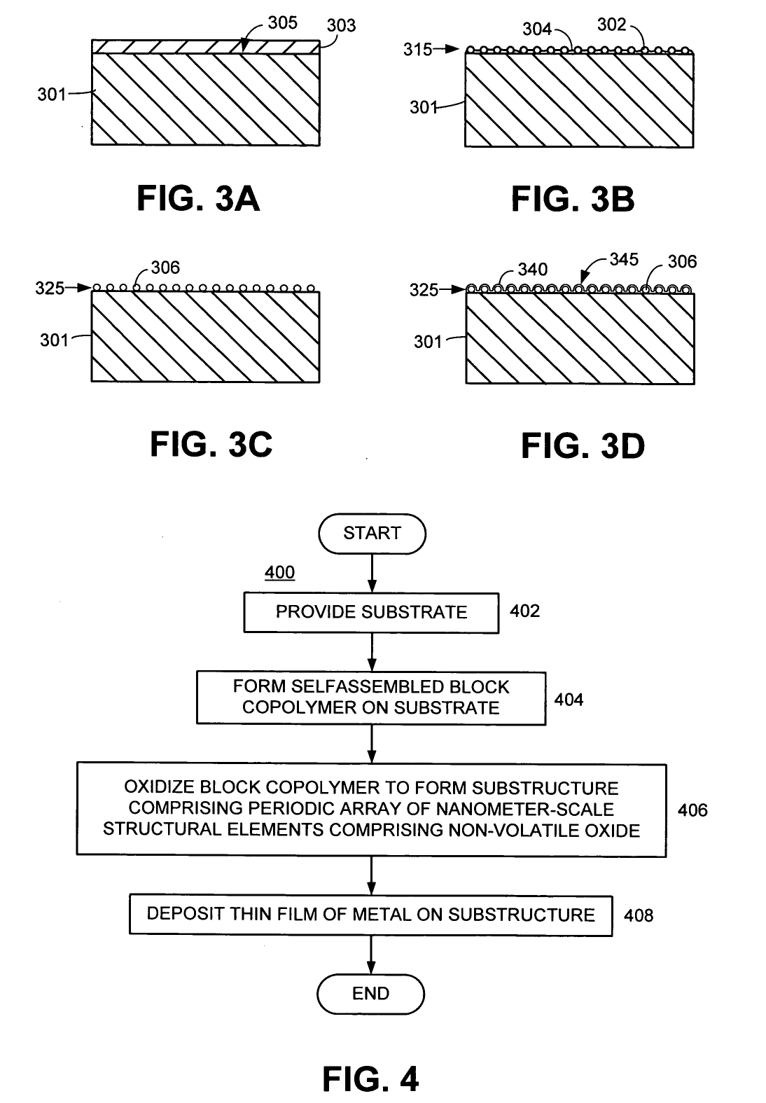

FIG. 2 is a schematic diagram illustrating a plan view of the substructure 125 shown in FIG. 1C. The substructure 125 is composed of nanometer-scale structural elements periodically arrayed on the surface 105 (FIG. 1A) of the substrate 101. In the example shown, the posts 106 constitute the structural elements of the substructure 125. The shape and size of the structural elements and the way in which the structural elements are arrayed are defined by the structure of the block copolymer 115 (FIG. 1B). FIG. 2 additionally shows that metal film 140 is deposited over the substructure 125. The surface of the metal layer 140 provides the textured metal surface 145 having nanometer-scale features. In the example shown, the posts 106 are cylindrical and are disposed with their circular cross section parallel to the plane of the surface 105 (FIG. 1A) of the substrate 101. However, as will be described in more detail below with reference to FIGS. 3A-3D, the above-described process can be used to form the structural elements of the substructure 125 with a shape different from that of the cylindrical posts 106. For example, the structural elements of the substructure 125 can be spherical.

FIGS. 3A through 3D are schematic cross-sectional views showing an artifact having a textured metal surface with nanometer-scale features in accordance with another embodiment of the invention at various stages in its fabrication. FIG. 3A shows a vector polymer film 303 deposited on the surface 305 of a substrate 301. The substrate 301 comprises silicon, quartz, glass or another suitable substrate material. For an SPR application, the substrate 301 is typically transparent. The vector polymer film 303 is deposited on the surface 305 of the substrate 301 by, for example, spin coating, dip coating, or another application process known in the art. The vector polymer film 303 is approximately 50-100 nanometers (rn) thick and is similar to the vector polymer film 103 described above with reference to FIG. 1A. However, the volume ratio of the two blocks in the vector polymer film 303 is less than the volume ratio of the two blocks of the vector polymer film 103 shown in FIG. 1A so that the block copolymer formed by annealing the vector polymer film 303 has a different morphology from that of the block copolymer 115 described above with reference to FIG. 1B.

FIG. 3B shows the substrate 301 and the vector polymer film 303 shown in FIG. 3A after the vector polymer film 303 has been annealed. Annealing the vector polymer film 303 causes the vector polymer film 303 to self-assemble into a block copolymer 315 having a nanometer-scale morphology defined by the volume ratio of the two blocks constituting the block copolymer 315. In the example shown, the volume ratio of the blocks that form the block copolymer 315 is such that the block copolymer self-assembles with a spherical morphology.

In the example shown in FIG. 3B, self-assembly of the block copolymer 315 results in a periodic array of microdomains embedded in a matrix. An exemplary one of the microdomains is illustrated at 302 and an exemplary part of the matrix is illustrated at 304. In an embodiment, the block copolymer 315 is formed using polystyrene-b-polyferrocenylmethylethylsilane (PS-PFEMS), where the material of the matrix 304 is polystyrene (PS) and the material of the microdomain 302 is polyferrocenylmethylethylsilane (PFEMS). In this example, the material that forms the microdomain 302 comprises organic material and inorganic species. The inorganic species are silicon and iron that form respective non-volatile oxides. The matrix 304 consists only of organic material. In other examples, the material of the microdomain 302 consists of only one organic species.

FIG. 3C shows the substrate 301 and the block copolymer 315 shown in FIG. 3B after the block copolymer 315 has been subject to oxidation. The block copolymer 315 is oxidized using, for example, oxygen (O₂) plasma etching or ultraviolet (UV)-ozonation, as known in the art. The oxidization process removes the organic components of the block copolymer 315 and converts each inorganic species in the microdomains 302 into a respective inorganic oxide. Specifically, the oxidation process removes the organic matrix 304 shown in FIG. 3B and the organic component of the microdomains 302. The oxidation process additionally converts the inorganic species in the microdomains 302 to respective inorganic oxides that form spheres 306. The spheres 306 are periodically arrayed on the surface 305 (FIG. 3A) of the substrate 301 in the same arrangement as the microdomains 302 described above with reference to FIG. 3B. The spheres 306 are structural elements that collectively constitute a substructure 325. Using current processing technology, the array of spheres 325 has a pitch of approximately 20 nanometers to approximately 100 nanometers and the spheres 325 are approximately 5 nanometers to approximately 50 nanometers in diameter.

FIG. 3D shows a thin layer 340 of a metal such as gold, silver, platinum, etc., deposited over the substructure 325 to complete the fabrication of an artifact 300 having a textured metal surface with nanometer-scale features. The metal layer 340 is applied over the substructure 325 by, for example, sputtering, metal evaporation, or another technique. The surface of the metal layer 340 provides the textured metal surface 345 of the artifact 300. The substructure 325 underlying the metal layer 340 defines the topology of the textured metal surface 345. The substructure 325 comprising a periodic array of the spheres 306 as nanometer-scale structural elements provides a high degree of control of both the size and the spacing of the nanometer-scale features of the textured metal surface 345.

FIG. 4 is a flowchart showing an example of a method 400 in accordance with an embodiment of the invention for forming an artifact having a textured metal surface with nanometer-scale features. In block 402, a substrate is provided. In block 404, a self-assembled block copolymer is formed on the substrate. The block copolymer comprises a matrix and a periodic array of microdomains embedded in the matrix. The microdomains comprise an inorganic species having a non-volatile oxide. In an embodiment, the microdomains of the block copolymer exhibit a cylindrical morphology. In another embodiment, the microdomains of the block copolymer exhibit a spherical morphology. Other morphologies are possible. In block 406, the self-assembled block copolymer is oxidized to form a substructure comprising a periodic array of nanometer-scale structural element comprising the non-volatile oxide. The oxidation process removes the organic component of the block copolymer and converts the inorganic component of the block copolymer in each microdomain into a respective nanometer-scale structure comprising the non-volatile inorganic oxide. The nanometer-scale structures are cylindrical or spherical in shape, depending on the shape of the microdomain from which they were formed. In block 408, a thin layer of a metal, such as gold, silver, platinum, etc., is deposited over the substructure. The surface of the metal layer provides the textured metal surface having nanometer-scale features defined by the nanometer-scale structural elements of the underlying substructure. The metal may be applied by sputtering, metal evaporation, or by another technique.

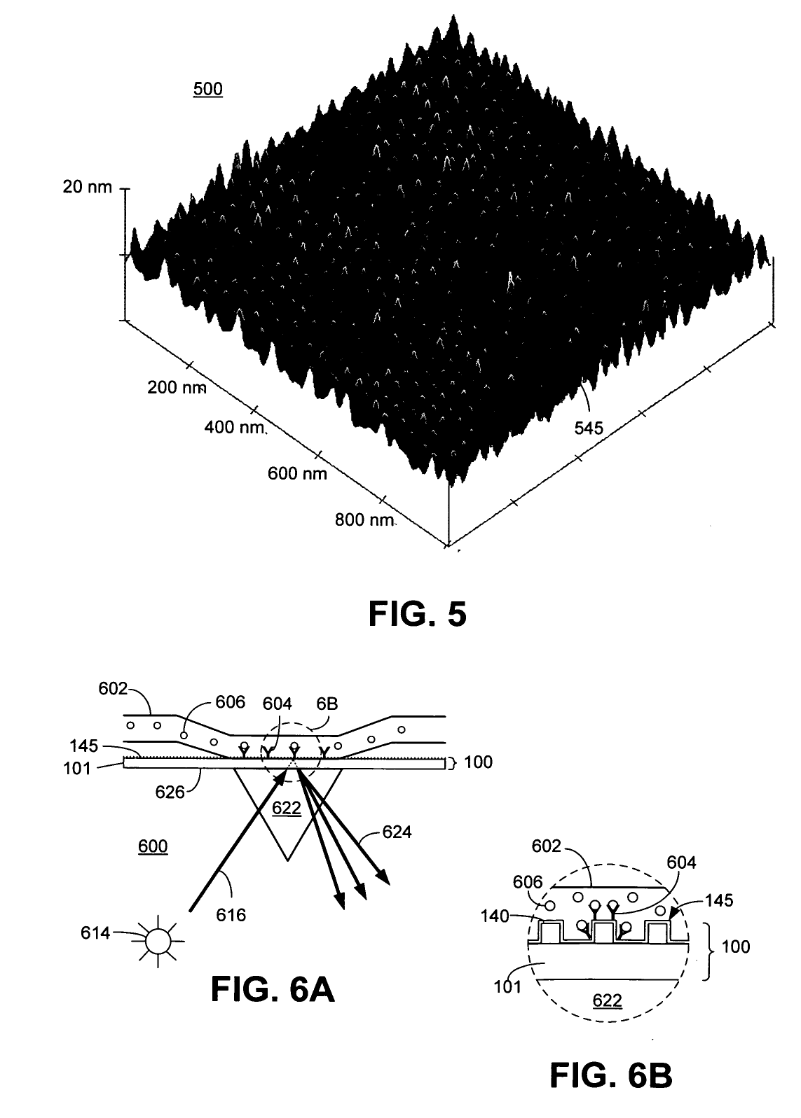

FIG. 5 is a schematic diagram illustrating an atomic force microscopy (AFM) image of an artifact 500 having a textured metal surface with nanometer-scale features in accordance with an embodiment of the invention. The nanometer scale features of the textured metal surface are defined by a periodic array of posts that were formed by applying and oxidizing a block copolymer comprising an inorganic species, as described above with respect to FIGS. 1A through 1C. A thin layer of metal is deposited on the nanometer-scale substructure comprising the posts. The surface of the metal layer provides the textured metal surface 545 with nanometer-scale features defined by the underlying posts. The artifact 500 can be used to enhance the performance of a surface plasmon resonance analysis device.

FIG. 6A is a schematic diagram illustrating the basic components of an apparatus for performing surface plasmon resonance analysis. The apparatus 600 incorporates an embodiment of the artifact 100 described above with reference to FIGS. 1A through 1D that serves as an SPR sensor element. As described above and also as shown in FIG. 6B, the artifact 100 comprises the transparent substrate 101 that supports nanometer-scale substructure 125 covered with the thin layer 140 of metal whose surface provides the textured metal surface 145 with nanometer-scale features defined by substructure 125. The textured metal surface 145 is coated with functionalizing biomolecules 604. The functionalizing biomolecules 604 are chosen to bind specifically with an analyte of interest 606 buffered in an aqueous buffer solution. The solution of the analyte of interest flows in a flow channel 602 and is directed towards the surface 145 of the artifact 100. An example of the functionalizing biomolecule 604 is an antibody and an example of the analyte-of-interest 606 is an antigen. However, other types of functionalizing biomolecules can be used to detect other types of analyte of interest.

A prism 622 is located on a surface 626 of the surface of the substrate 101 of the artifact 100 opposite the textured metal surface 145. A light source 614 is located to direct polarized light 616 into the prism 622 as shown. The polarized light passes through the prism 622 and the substrate 101, reflects off the textured metal surface 145 and passes back through the substrate 101 and the prism 622 as reflected light 624. The angle at which the SPR absorption line occurs depends on whether the analyte of interest has bound to the functionalizing biomolecules 604. The difference in the angle at which the SPR absorption line occurs with and without an analyte of interest can be represented by a signal whose amplitude is proportional to the volume of biomolecules bound near the textured metal surface 145 of the artifact 100.

FIG. 6B is a schematic diagram showing a detail view of the artifact 100 as embodied in the apparatus 600. The textured metal surface 145 of the artifact 100 is coated with functionalizing biomolecules 604. The functionalizing biomolecules 604 are chosen to specifically bind with analyte of interest 606 supplied in an aqueous buffer solution. The aqueous buffer solution flows in the flow channel 602 past the nanometer-scale textured metal surface 145 of the artifact 100, as described above.

This disclosure describes the invention in detail using illustrative embodiments. However, it is to be understood that the invention defined by the appended claims is not limited to the precise embodiments described.

What is claimed is:

1. An artifact having a textured metal surface with nanometer-scale features, the artifact comprising:
a substrate;
a substructure over the substrate, the substructure comprising a periodic array of nanometer-scale structural elements comprising an inorganic oxide; and
a metal film over the substructure.

2. The artifact of claim 1, in which the inorganic oxide constituting the structural elements comprises an inorganic species remaining after oxidation of a self-assembled block copolymer, the self-assembled block copolymer comprising a matrix and a periodic array of microdomains embedded in the matrix, the microdomains comprising the inorganic species.

3. The artifact of claim 2, in which the matrix comprises one of polystyrene (PS) and polyisoprene (PI).

4. The artifact of claim 3, in which the microdomains comprise one of polydimethylsiloxane (PDMS), polyferrocenylmethylethylsilane (PFEMS), polyvinyl-ethylphenolsilane (PFPMS) polyvinylmethylsiloxane (PVMS), polybutadiene (PB), where the polybutadiene (PB) is stained by OsO₄, and polyvinylpridine (PVP), where the pyridine group forms a coordination bond with the inorganic species.

5. The artifact of claim 1, in which the metal comprises one of gold, silver and platinum.

6. The artifact of claim 2, in which the microdomains exhibit a cylindrical morphology.

7. The artifact of claim 2, in which the microdomains exhibit a spherical morphology.

8. The artifact of claim 1, in which the nanometer-scale structural elements exhibit a cylindrical morphology.

9. The artifact of claim 1, in which the nanometer-scale structural elements exhibit a spherical morphology.

10. A method of making an artifact having a textured metal surface with nanometer-scale features, the method comprising:
providing a substrate;
forming a self-assembled block copolymer on the substrate, the self-assembled block copolymer comprising a matrix and a periodic array of microdomains embedded in the matrix, the microdomains comprising an inorganic species having a non-volatile oxide;
oxidizing the self-assembled block copolymer to form a substructure comprising a periodic array of nanometer-scale structural elements comprising the non-volatile oxide; and
depositing a film of metal over the substructure.

11. The method of claim 10, in which:
the forming comprises depositing a vector polymer on the substrate and annealing the vector polymer; and
the applying comprises sputtering the metal onto the substructure.

12. The method of claim 10, in which the matrix of the self-assembled block copolymer comprises one of polystyrene (PS) and polyisoprene (PI).

13. The method of claim 12, in which the microdomains of the self-assembled block copolymer comprise one of polydimethylsiloxane (PDMS), polyferrocenylmethylethylsilane (PFEMS), polyvinylethylphenolsilane (PFPMS) polyvinylmethyisiloxane (PVMS), polybutadiene (PB), where the polybutadiene (PB) is stained by OSO₄, and polyvinylpridine (PVP), where the pyridine group forms a coordination bond with inorganic species.

14. The method of claim 10, in which the structural elements exhibit a cylindrical morphology.

15. The method of claim 10, in which the structural elements exhibit a spherical morphology.

16. The method of claim 10, in which the metal comprises one of gold, silver and platinum.

17. A method of making a sensor for a surface plasmon resonance analysis apparatus, the method comprising:
providing a transparent substrate;
forming a self-assembled block copolymer on the transparent substrate, the self-assembled block copolymer comprising a matrix and a periodic array of microdomains embedded in the matrix, the microdomains comprising an inorganic species having a non-volatile oxide;
oxidizing the self-assembled block copolymer to form a substructure comprising a periodic array of nanometer-scale structural elements comprising the inorganic oxide; and
depositing a film of metal over the substructure.

18. The method of claim 17, in which:
the forming comprises depositing a vector polymer on the substrate and annealing the vector polymer; and
the applying comprises sputtering the metal onto the substructure.

19. The method of claim 17, in which the matrix comprises one of polystyrene (PS) and polyisoprene (PI).

20. The method of claim 19, in which the microdomains comprise one of polydimethylsiloxane (PDMS), polyferrocenylmethylethylsilane (PFEMS), polyvinyl-ethylphenolsilane (PFPMS) polyvinylmethylsiloxane (PVMS), polybutadiene (PB), where the polybutadiene (PB) is stained by OsO₄, and polyvinylpridine (PVP), where the pyridine group forms a coordination bond with inorganic species.
